(19) United States
(12) Patent Application Publication
(10) Pub. No.: US 2014/0297363 A1
(43) Pub. Date: Oct. 2, 2014

(54) On-Site and In-Store Content Personalization and Optimization

(71) Applicant: Staples, Inc., Framingham, MA (US)

(72) Inventor: Pratabkumar Vemana, Westborough, MA (US)

(73) Assignee: Staples, Inc., Framingham, MA (US)

(21) Appl. No.: 14/226,618

(22) Filed: Mar. 26, 2014

Related U.S. Application Data
(60) Provisional application No. 61/805,151, filed on Mar. 26, 2013.

(51) Int. Cl. G06Q 30/02

(52) U.S. Cl. CPC G06Q 30/0201; G06Q 30/0269
USPC 705/7.29

(57) ABSTRACT

In an example implementation, a method receives first-party data and third-party data and generates a customer profile for the customer of a merchant based on the first-party data and the third-party data. The customer profile has a set of attributes. The method further generates a set of rules for evaluating a disposition of the customer based on the set of attributes of the customer profile, receives real-time intelligence data associated with the customer during a visit to the merchant or an interaction with marketing content of the merchant, predicts the disposition of the customer using the real-time intelligence data and one or more of the rules, and adapts a shopping experience of the customer during the visit to the merchant or a marketing content of the merchant for the customer using the predicted disposition.

### CROSS-REFERENCE TO RELATED APPLICATIONS

This application claims the benefit under 35 U.S.C. §119(e) of U.S. Provisional Application No. 61/805,151, entitled “On-Site Content Personalization and Optimization Leveraging Big Data”, filed on Mar. 26, 2013, the entire contents of which is incorporated herein by reference.

### BACKGROUND

The specification relates to automatically personalizing and optimizing on-site and in-store content.

The assortment of products available online is ever expanding, making it increasingly difficult for customers to find the right products they want for right price and making it increasingly difficult for merchants to develop a proper understanding of their customers and the products they might want. This often leads to low customer satisfaction and poor conversion rates. Converting potential customers to purchasing customers is extremely important in a commerce environment where customers shop for products at different sources and may leave and return several times before purchasing.

Even a slight increase in percentage of conversions of potential customers to purchasing customers can make a large difference in revenue for a merchant. One way to improve conversion is to optimize experience for the customer based on his specific interests, but currently only a small percentage of customers are identifiable because of how quick the interactions between the customers and the merchant may be. As a result, many current solutions are unable to gain a deep understanding of their customers' preferences unless the users are registered users and have divulged certain preferences. Thus, these solutions are unable to effectively personalize the customer experience for the majority of potential customers, and as a result, are prone to lower conversion rates as well as customer satisfaction and loyalty.

### SUMMARY

The subject matter described in this disclosure in general relates to personalizing and optimizing on-site and in-store content. According to one innovative aspect of the subject matter in this disclosure, a method receives first-party data and third-party data and generates a customer profile for the customer of a merchant based on the first-party data and the third-party data. The customer profile has a set of attributes. The method further generates a set of rules for evaluating a disposition of the customer based on the set of attributes of the customer profile, receives real-time intelligence data associated with the customer during a visit to the merchant or an interaction with marketing content of the merchant, predicts the disposition of the customer using the real-time intelligence data and one or more of the rules, and adapts a shopping experience of the customer during the visit to the merchant or a marketing content of the merchant for the customer using the predicted disposition.

The technology described herein is particularly advantageous in a number of respects. For instance, the technology can improve recognition of the merchant's customers, predict the disposition of the customers, and adapt their shopping experiences accordingly. This personalization, which is based on an enhanced understanding of the customer, improves the customers' experience and increases the probability that they will purchase products during their visits, thus yielding higher conversion rates and revenues. Further, the technology helps merchant significantly improve their understanding of their customers and the customers' needs. It should be understood, however, that this list of features and advantages is not all-inclusive and many additional features and advantages are contemplated and fall within the scope of the present disclosure. Moreover, it should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an example system for on-site content personalization and optimization.

FIG. 2A is a block diagram illustrating an example enterprise system.

FIG. 2B is a block diagram illustrating an example third-party server.

FIG. 3A is an example of first-party data.

FIG. 3B is an example of third-party data.

FIG. 4 is a block diagram illustrating example data flows associated with an example aggregator engine.

FIG. 5 is a block diagram illustrating the input and output of a rules engine, and the interaction of the rules engine with the ecommerce server.

FIG. 6 is an example of attributes in an enhanced customer profile.

FIG. 7 is a data flow diagram illustrating an example data flow for the system.

FIG. 8 is a flowchart illustrating an example method for personalizing and optimizing on-site content.

FIGS. 9A and 9B are a flowchart illustrating an example method for personalizing and optimizing on-site content.

FIG. 10 is a flowchart illustrating an example method for combining first-party data and third-party data to form an enhanced customer profile having enhanced attributes.

FIG. 11 is a flowchart illustrating an example method for determining the current intent of the customer based on the real-time intelligence data and the customer profile.

FIG. 12 is a flowchart illustrating an example method for adapting the shopping experience of the customer based on the rules and the current intent of the customer.

FIG. 13 is a graphic representation of an example personalized interface provided by the system.

### DETAILED DESCRIPTION

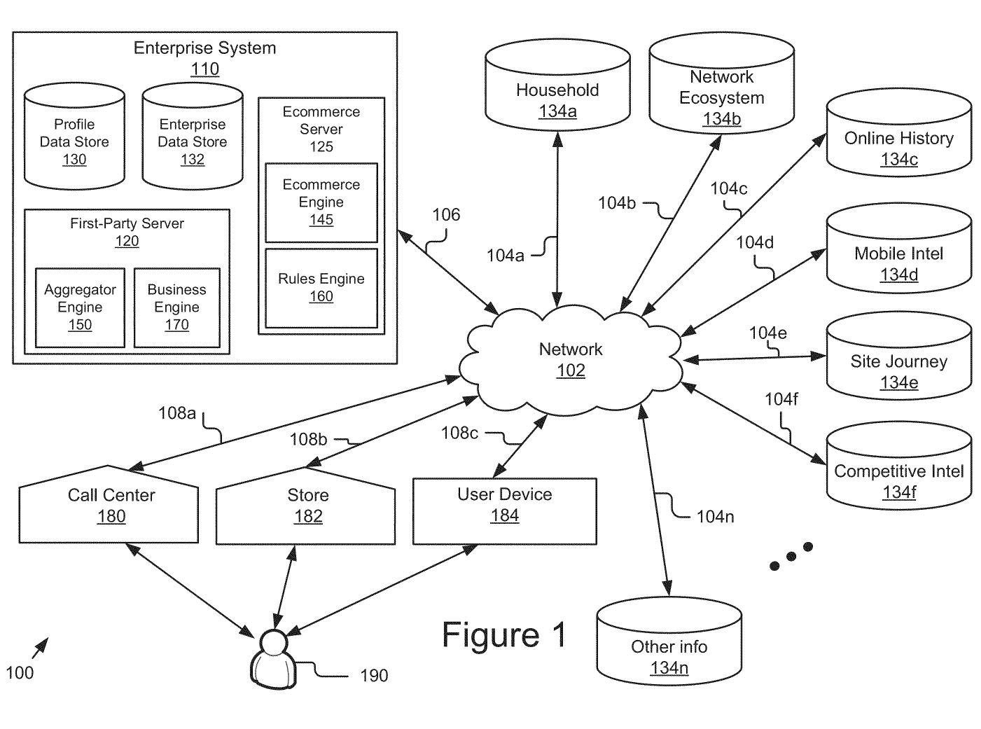

FIG. 1 is a block diagram of example systems 100 for on-site content personalization and optimization. The illustrated system 100 includes an ecommerce system 110, third-party data storage devices 134a . . . 134n, a call center 180, a store 182, and a user device 184, which are electronically communicatively coupled via a network 102, although other system configurations are possible including other devices, systems, and networks. For example, the system 100 could include any number of enterprise systems 110, call centers 180, stores 182, user devices 184, and/or other systems and devices.

The enterprise system 110 and its components may be coupled to the network 102 via signal line 106, the data storage devices 134a . . . 134n and their components may be coupled to the network 102 via signal lines 104a . . . 104n, the call center 180 and its components may be connected to the network 102 via signal line 108a, the store 182 and its components may be connected to the network 102 via signal line 108b, the user device 184 and its components may be coupled to the network 102 via signal line 108c. The customer/user 190 may access one or more of the devices of the system 100. For example, as depicted, the user 190 may access the call center 180, the store 182, or the user device 184.

The network 102 may include any number of networks and/or network types. For example, the network 102 may include, but is not limited to, one or more local area networks (LANs), wide area networks (WANs) (e.g., the Internet), virtual private networks (VPNs), mobile (cellular) networks, wireless wide area network (WWANs), WiMAX® networks, Bluetooth® communication networks, various combinations thereof, etc.

The enterprise system 110 is a computing system capable of providing backend operations support to both virtual and physical retail/commercial sites, such as the call center 180, the store 182, and the ecommerce server 125 including, for example, receiving, managing, analyzing, storing, and providing these sites access to inventory, sales, rewards, product, and analytics data. The enterprise system 110 may include one or more computing devices having data processing, storing, and communication capabilities. For example, the enterprise system 110 may include one or more hardware servers, server arrays, storage devices and/or systems, etc. In some implementations, the enterprise system 110 may include one or more virtual servers, which operate in a host server environment and access the physical hardware of the host server including, for example, a processor, memory, storage, network interfaces, etc., via an abstraction layer (e.g., a virtual machine manager). The computing resources of the enterprise system 110 may be distributed over the network 102 in disparate locations or may reside in the same location.

As depicted, the enterprise system 110 may include a first-party server 120, an ecommerce server 125, a profile data store 130, an enterprise data store 132, and other possible data stores, servers, engines, or other devices.

The first-party server 120 may include one or more computing devices having data processing, storing, and communication capabilities. For example, the first-party server 120 may include one or more hardware servers, server arrays, storage devices and/or systems, etc. In some implementations, the first-party server 120 may include one or more virtual servers, which operate in a host server environment and access the physical hardware of the host server including, for example, a processor, memory, storage, network interfaces, etc., via an abstraction layer (e.g., a virtual machine manager).

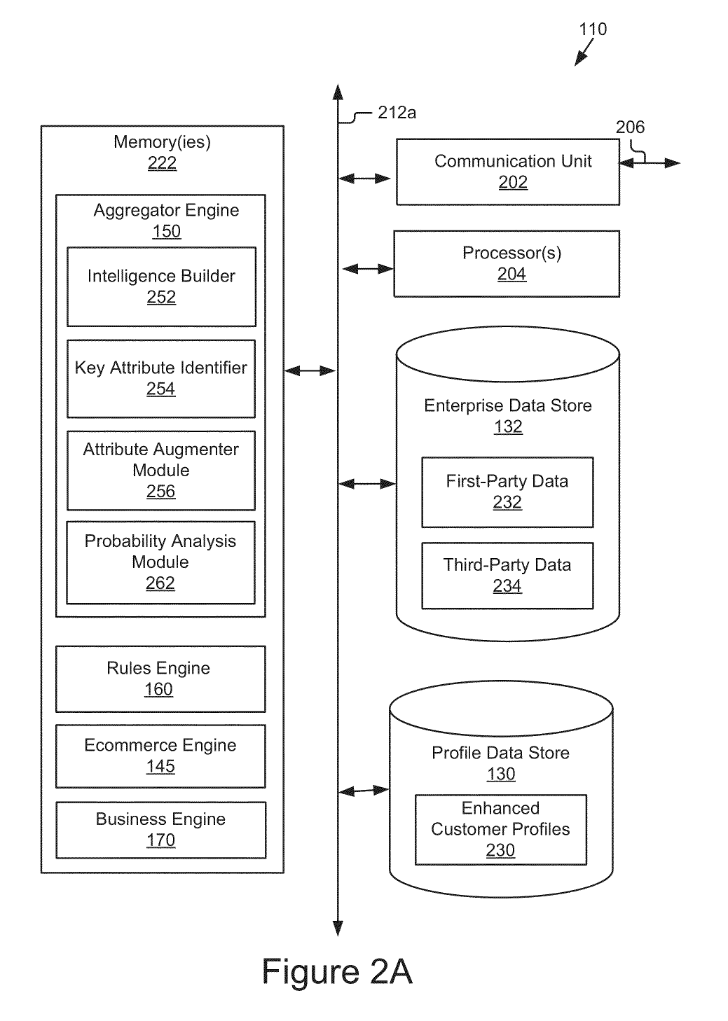

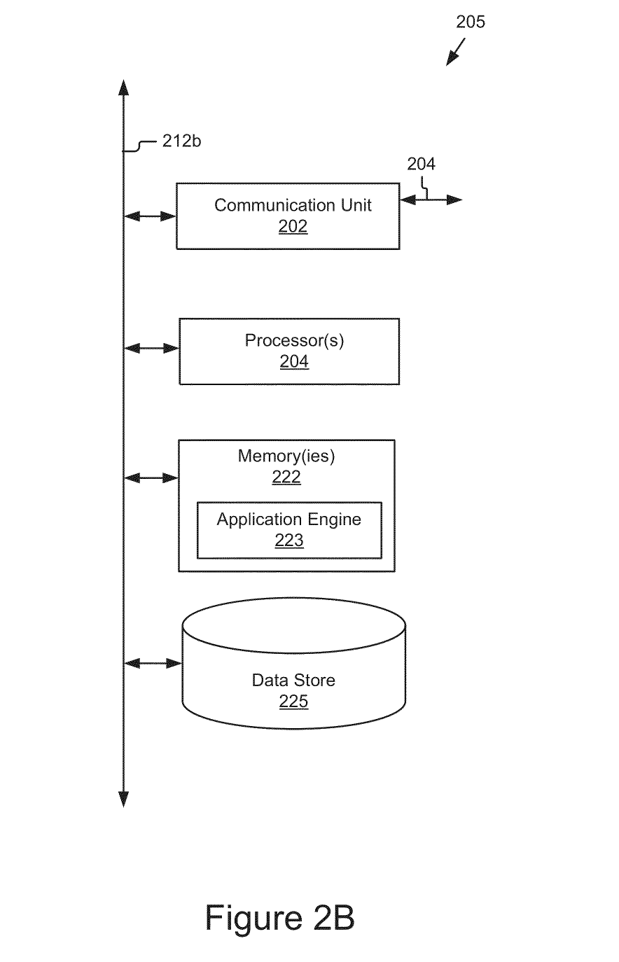

In the depicted implementation, the first-party server 120 includes an aggregator engine 150 operable to combine first-party data and third-party data in such a way as to provide deeper understanding of attributes pertaining to the user 190. The aggregator engine 150 is described in further detail herein with reference to at least FIG. 2A.

In the depicted implementation, the first-party server 120 also includes a business engine 170 operable to allow user access to the data stored in the profile data store 130 and/or to the data stored in the enterprise data store 132.

In some implementations, the business engine 170 may provide business data pertaining to individual users, users in the aggregate, or any particular type of data useful for purposes of marketing, merchandising, strategy, finance, or other business uses and analytics.

In some implementations, the business engine 170 may provide access to the profile data store 130, the rules engine 160, and/or any other component of the system 100 to allow modification of the data or modules of the system 100. For example, administrators may input and/or modify various rules used by the rules engine 160 to generate predictions based on the disposition of the customers, as reflected by the real-time intelligence data.

In some implementations, the business engine 170 is configured to personalize the marketing content provided to customers. This personalization is based on the predictions made by the rules engine 160. The business engine 170 is coupled to the rules engine 160 to receive the predictions.

The ecommerce server 125 may include one or more computing devices having data processing, storing, and communication capabilities. For example, the ecommerce server 125 may include one or more hardware servers, server arrays, storage devices and/or systems, etc. In some implementations, the first-party server 120 may include one or more virtual servers, which operate in a host server environment and access the physical hardware of the host server including, for example, a processor, memory, storage, network interfaces, etc., via an abstraction layer (e.g., a virtual machine manager).

In the depicted implementation, the ecommerce server 125 includes an ecommerce engine 145 operable to provide an ecommerce service/marketplace for various products and may store and provide access to product information (e.g., images, descriptions, categories, specifications, reviews, ratings, retailers, etc.) in a data store, such as the enterprise data store 132. The ecommerce engine 145 may also place and provide for order fulfillment for the products including order delivery status and item returns. For example, a customer/user 190 may place orders for and/or pay for products ordered on the ecommerce marketplace using the call center 180, kiosks or point of sale devices in the store 182, or from the user device 184.

In some implementations, the ecommerce engine 145 and/or the business engine 170 may personalize the shopping experience of the user 190 via interaction with a call center 180, a computer system of a store 182, and/or an application executable on the user's user device 184, etc. The shopping experience of the customer/user 190 may be affected by augmenting a website or a software program, an automated response or a prompt displayed to an employee at a call center 180 and/or any display, advertisement, kiosk, point of sale, or any other device at a store 182, a message sent to the user, advertisements displayed to the user, etc.

In some implementations, the rules engine 160 can send predictions to the call center 180 and the call center's 180 software (e.g., the business engine 170, other software, etc.) can prompt a relevant employee at the call center 180 to suggest products, prices, etc., to the customer when that customer calls. The call center's 180 phone system, which may be included in the business engine 170 and/or other software that is coupled to and/or included in the enterprise system 110, can collect real-time intelligence data about the customer based on a phone number associated with the phone the customer is calling from and any information the customer enters into the phone, and use that information to access the customer's enhanced profile, which can then be used by the rules engine 160 to generate predictions about the customer's disposition (e.g., products recently purchased, other calls the customer has made, promotions the customer received, products routinely ordered by phone, etc.).

In the depicted implementation, the ecommerce server 125 also includes a rules engine 160 operable to process the rules on data that is associated with the customer (e.g., the customer's enhanced profile, real-time intelligence data, etc.) to personalize the ecommerce experience of the customer.

In some implementations, the rules engine 160 may generate predictions based on the disposition of a given customer. The disposition of the customer may reflect the customer's proclivities, intent, preferences, needs, inclinations, etc. Examples of predictions are discussed in further detail elsewhere herein. A customer's disposition (e.g., current intent) may be evaluated by rules processed by the rules engine 160. As an example, disposition may be evaluated by a given rule based on current or recent actions by a particular customer, and/or patterns, behaviors, and/or other data learned from computer learning methods (e.g. if the customer is clicking through several different related products, the customer may not have a good idea of what specific product the customer intends to purchase).

In some implementations, rules processed by the rules engine 160 may predict various items that can be used to change the ecommerce experience of the customer. The rules may be processed to produce several different outcomes and the rules engine 160 may select one or more of the outcomes based on their effectiveness. In some cases, effectiveness is measured by the likelihood that the outcome would influence a particular customer's actions.

In some implementations, the rules may be designed to predict the shopping intentions of the customer/user 190 (e.g., a particular customer/user 190 may have a pattern of calling a call center 180 then purchasing a product four hours later. The rules can recognize if the customer has failed to purchase the product according the pattern and may offer an additional incentive to aid in converting the potential sale to an actual sale.). The rules may take advantage of specific information about a particular customer/user 190 to display an applicable product for purchase. E.g., the rules may take the attribute indicating that a customer/user 190 is, with a certain probability, a health care provider and that most similar health care providers purchase a certain type of paper, and may suggest this particular paper to the customer/user 190.

In some implementations, the rules engine 160 may monitor the actions of the customer/user 190, measure the results of changing the shopping experience of the customer/user 190, and/or for updating the profile data store 130 with the results describing the effectiveness of changing the shopping experience of the user 190. The rules and rules engine 160 are discussed in further detail elsewhere herein.

The profile data store 130 may store enhanced customer profiles 230 as generated, stored, and modified by the aggregator engine 150. The profile data store 130 is discussed in further detail elsewhere herein.

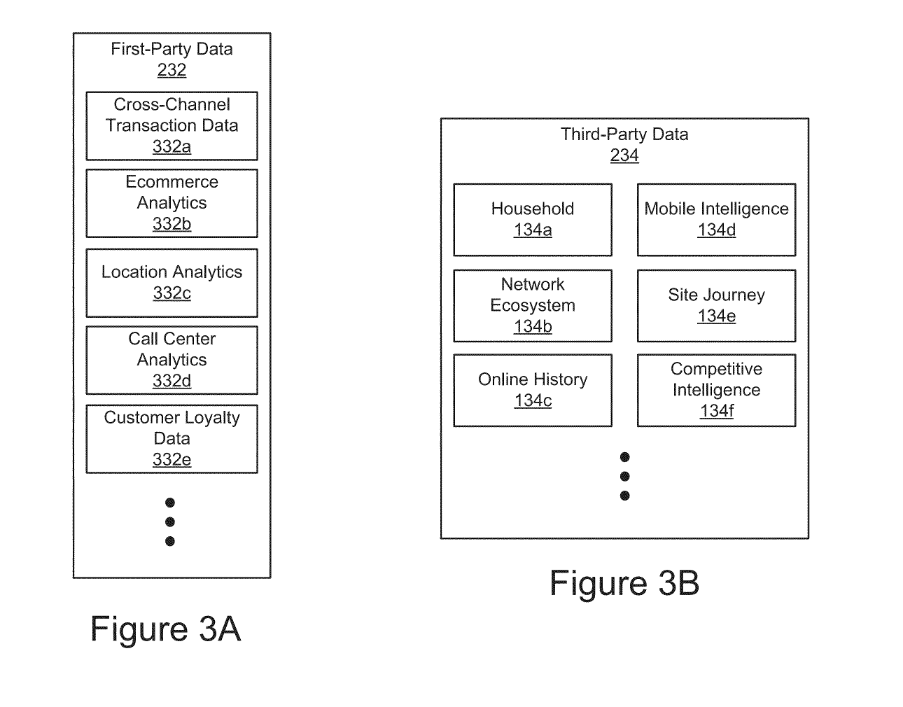

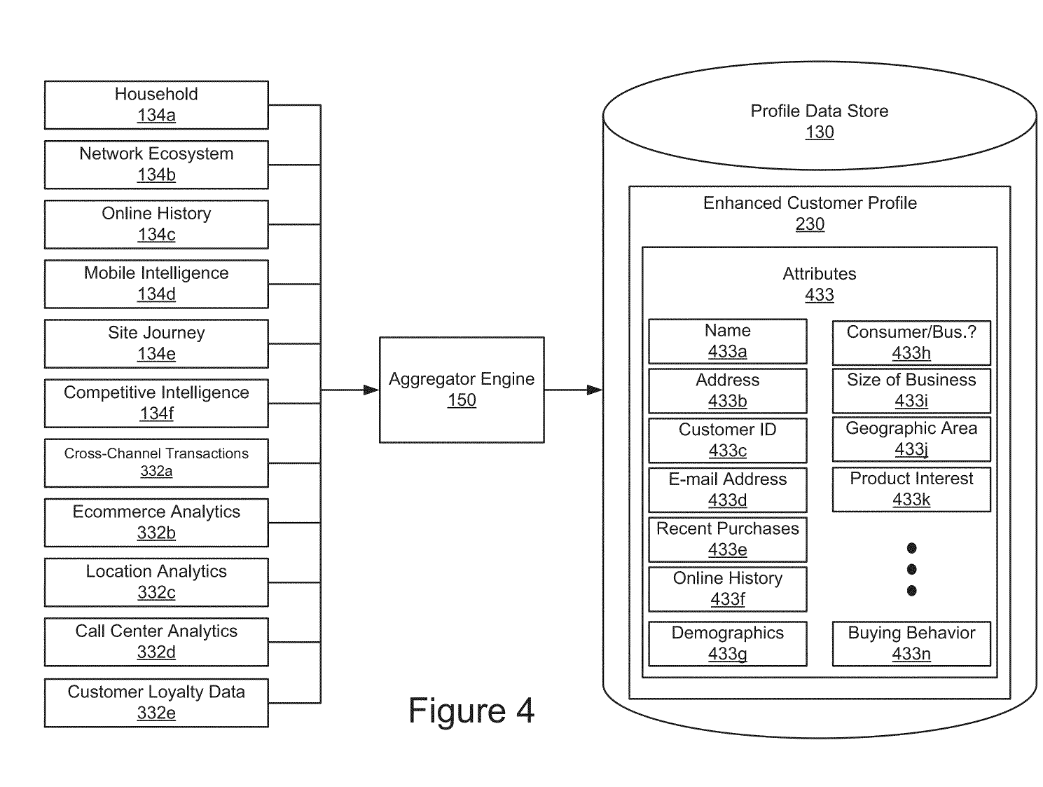

The enterprise data store 132 may store first-party data 232 and third-party data 234. FIGS. 3A and 3B are block diagrams showing example representations of first-party data 232 and third-party data 234, respectively. The first-party data 232 may include one or more of cross-channel transaction data 332a, ecommerce analytics data 332b, location analytics data 332c, call center analytics data 332d, customer loyalty data 332e, although other types of data may also be included and are contemplated.

Cross-channel transaction data 332a may include purchase history, past use of incentives, patterns of user behavior, predictive modeling based on past transactions, and any other data that learned from cross-channel (e.g., retail and online) transactions.

Ecommerce analytics data 332b may include data describing past user interaction with the ecommerce server 125, path data regarding past behavior of a customer/user 190 entering, interacting with, and leaving interaction the ecommerce server 125 and/or a first-party website, and any other data that can be learned from user interactions with a first-party website.

Location analytics data 332c may include location and timing data associated with purchases and actions of a user, influence of location on the user's actions, and any other data that can be learned from a user's location.

Call center analytics data 332d may include any information about managed customers and/or any customer who contacts the call center 180; this data can include past purchases, purchase patterns and trends, complaints lodged by the customer, information about the customer and/or the business of the customer, and any other data learned from a call center 180.

Customer loyalty data 332e may include loyalty account data including, for example, reward points, account numbers, names, home addresses, phone numbers, e-mail addresses, preferences, etc. The customer loyalty data 332e may also include sales data, product data, and other types of data associated with customer loyalty. Sales data may include purchase history and fulfillment data received from the virtual and physical retail sites associated with the enterprise system 110 including, for example the store 182 and/or the ecommerce server 125. Inventory data may include, for example, pricing information, which products are carried by the retail sites (e.g., the store 182 and the ecommerce service), whether the products are in-stock, whether to products are available via the ecommerce services, whether the products are backordered or discontinued, etc. Product data may include, for example, product identifiers, names, descriptions, manufacturer, specifications, photos, videos, reviews, etc.

Third-party data 234 may include household data 134a, network ecosystem data 134b, online history data 134c, mobile intelligence data 134d, site journey data 134e, competitive intelligence data 134f, and other information data 134n.

Household data 134a may include demographics data, gender, whether the user is a consumer or business, the size of the business if applicable, address or location data, household income, e-mail address, and other data associated with a customer's/user's 190 identity.

Network ecosystem data 134b may include device preference data, channel influence, overall spending potential, carrier intelligence, and other data that can be learned based on internet service provider (ISP) data and intelligence.

Online history data 134c may include demographics, interests, recent searches, generic profile information, and other information learned from web-cookies and/or a user's online history.

Mobile intelligence data 134d may include data reflecting moments of influence for both online and offline behaviors, such as a user's behavior when the user is near a retailer and other information that can be learned from a user's mobile device.

Site journey data 134e may include data describing the path a user takes leading from one webpage to another, effectiveness of past influences and different paths on a user's behaviors, number of trips a user takes to a certain site, amount of time a user spends looking at a certain webpage or portion of a webpage, and other data reflecting a user's interests in specific products and/or categories of products as well as other data reflecting previous paths and the results of past influences on the behavior of the user 190.

Competitive intelligence data 134f may include current market conditions, competitors' prices of products, competitors' incentives, analysis around competitors' performance, and other data regarding or generated by competitors. Other information data 134n may include any other data collected by third-party sources.

The data stored by the data stores 130, 132, and/or 134a . . . 134n may be organized and queried using various criteria. Examples of query parameters may include any type of data stored by the data stores, such as any attribute in a customer profile, e-mail address, IP address, demographics data, user id, rewards account number, product identifier, or any other information. The data stores 130, 132, and/or 134a . . . 134n may include data tables, databases, or other organized collections of data. The data stores 130, 132, and/or 134a . . . 134n may all be included in the same storage device or system, or disparate storage systems. In some implementations, the data stores 130, 132, and/or 134a . . . 134n may include a database management system (DBMS) operable by the enterprise system 110. For example, the DBMS could include a structured query language (SQL) DBMS, a NoSQL DMBS, various combinations thereof, etc. In some instances, the DBMS may store data in multi-dimensional tables comprised of rows and columns, and manipulate, i.e., insert, query, update and/or delete, rows of data using programmatic operations. In some implementations, the data stores 130, 132, and/or 134a . . . 134n may be connected to a main data store (not shown) that is shared among and accessible to the components of the enterprise system 110.

The call center 180 represents one or more offices used for the purpose of receiving and/or transmitting a large volume of calls. The call center 180 may be confined to a one or more offices, whether physical or virtual. The call center 180 may include one or more networked computing devices equipped with hardware and software configured to enable the call center 180 to process calls consisting of audio calls, video calls, e-mail, mobile texting, online chat, fax, instant message, or any other form of remote communication between a user 190 and a company. The call center 180 may include humans interacting with the user 190, automated computer systems interacting with the user, or any combination thereof.

The store 182 represents a brick-and-mortar retail establishment offering various products to its customers. The store 182 may include a point of sale system for processing sale of products to customers, an in-store stock of products, one or more kiosks, digital advertising displays, etc. The point of sale system (not shown) may include one or more computing and/or storage devices for checking out customers, such as cash registers having keyboards, cash drawers, receipt printers, displays, optical scanners, credit card readers, etc.; tablets, laptops, mobile devices, desktops, servers, storage devices, digital displays, etc. The point of sale system may receive marketing content from the business engine 170 and display corresponding content to one or more customers, as discussed elsewhere herein. The point of sale system may transmit information received at checkout including sales data, customer loyalty data, inventory data, etc., to the enterprise system 130 for processing and storage.

The user device 184 includes one or more computing devices having data processing and communication capabilities. In some implementations, a user device 184 may include a processor (e.g., virtual, physical, etc.), a memory, a power source, a communication unit, and/or other software and/or hardware components, such as a display, graphics processor, wireless transceivers, keyboard, camera, sensors, firmware, operating systems, drivers, various physical connection interfaces (e.g., USB, HDMI, etc.). The user device 184 may couple to and communicate with one another and the other entities of the system 100 via the network 102 using a wireless and/or wired connection.

Examples of user devices 184 may include, but are not limited to, mobile phones, tablets, laptops, desktops, netbooks, server appliances, servers, virtual machines, TVs, set-top boxes, media streaming devices, portable media players, navigation devices, personal digital assistants, etc. While a single user device 184 is depicted in FIG. 1, the system 100 may include any number of user devices 184. In addition, the user device 184 may be the same or different types of computing devices.

The user device 184 may include a user/client application (not shown). The user application may be storable in a memory (not shown) and executable by a processor (not shown) of a user device 184 to provide for user interaction, receive user input, present information to the user via a display (not shown), and send data to and receive data from the other entities of the system 100 via the network 102. In some implementations, the user application may generate and present the user interfaces based at least in part on information received from the ecommerce server 125 via the network 102. For example, a customer/user 190 may use the user application to receive the personalized shopping experience provided by the ecommerce engine 145, view various products available online or in the store 182, etc. In some implementations, the user application includes a web browser and/or code operable therein, a customized client-side application (e.g., a dedicated mobile app), a combination of both, etc.

It should be understood that the system 100 illustrated in FIG. 1 is representative of an example system for on-site content personalization and optimization, and that a variety of different system environments and configurations are contemplated and are within the scope of the present disclosure. For instance, various functionality may be moved from a server to a client, or vice versa, data may be consolidated into a single data store or further segmented into additional data stores, moved to remote and/or local data stores, etc., and some implementations may include additional or fewer computing devices, services, and/or networks, and may implement various functionality client or server-side. Further, various entities of the system 100 may be integrated into to a single computing device or system or additional computing devices or systems, etc.

FIGS. 2A and 2B are block diagrams of an example enterprise system 110 and an example third-party server 205. As depicted, the enterprise system 110 may include a processor(s) 204, a memory(ies) 222, a communication unit 202, a profile data store 130, an enterprise data store 132, which may be communicatively coupled by a communication bus 212a. As depicted, the third-party server 205 may include a processor(s) 204, a memory(ies) 222, a communication unit 202, and a data store 225, which may be communicatively coupled by a communication bus 212b. The enterprise system 110 depicted in FIG. 2A and the third-party server 205 are provided by way of example and it should be understood that they may take other forms and include additional or fewer components without departing from the scope of the present disclosure. For example, while not shown, the enterprise system 110 may include input and output devices (e.g., keyboard, display, etc.), various operating systems, sensors, additional processors, and other physical configurations.

The processor(s) 204 may execute software instructions by performing various input/output, logical, and/or mathematical operations. The processor(s) 204 may have various computing architectures to process data signals including, for example, a complex instruction set computer (CISC) architecture, a reduced instruction set computer (RISC) architecture, and/or an architecture implementing a combination of instruction sets. The processor(s) 204 may be physical and/or virtual, and may include a single core or plurality of processing units and/or cores. In some implementations, the processor(s) 204 may be capable of generating and providing electronic display signals to a display device (not shown), supporting the display of images, capturing and transmitting images, performing complex tasks including various types of feature extraction and sampling, etc. In some implementations, the processor(s) 204 may be coupled to the memory(ies) 222 via the bus 212a to access data and instructions therefrom and store data therein. The bus 212a may couple the processor(s) 204 to the other components of the enterprise system 110 including, for example, the memory(ies) 222, the communication unit 202, the profile data store 130, and the enterprise data store 132.

The memory(ies) 222 may store and provide access to data to the other components of the enterprise system 110. In some implementations, the memory(ies) 222 may store instructions and/or data that may be executed by the processor(s) 204. For example, as depicted, the memory(ies) 222 may store the ecommerce engine 145 and its components, the aggregator engine 150 and its components, the rules engine 160 and its components, the business engine 170 and its components, and/or the application engine 223. The memory(ies) 222 is also capable of storing other instructions and data, including, for example, an operating system, hardware drivers, other software applications, databases, etc. The memory(ies) 222 may be coupled to the bus 212a or 212b for communication with the processor(s) 204 and the other components of enterprise system 110 or third-party server 205.

The memory(ies) 222 include a non-transitory computer-usable (e.g., readable, writeable, etc.) medium, which can be any tangible non-transitory apparatus or device that can contain, store, communicate, propagate or transport instructions, data, computer programs, software, code, routines, etc., for processing by or in connection with the processor(s) 204. In some implementations, the memory(ies) 222 may include one or more of volatile memory and non-volatile memory. For example, the memory(ies) 222 may include, but is not limited, to one or more of a dynamic random access memory (DRAM) device, a static random access memory (SRAM) device, a discrete memory device (e.g., a PROM, FPROM, ROM), a hard disk drive, an optical disk drive (CD, DVD, Blu-ray™, etc.). It should be understood that the memory(ies) 222 may be a single device or may include multiple types of devices and configurations.

The bus 212a and 212b can include a communication bus for transferring data between components of a computing device or between computing devices, a network bus system including the network 102 or portions thereof, a processor mesh, a combination thereof, etc. The software communication mechanism can include and/or facilitate, for example, inter-process communication, local function or procedure calls, remote procedure calls, etc.

The communication unit 202 may include one or more interface devices (I/F) for wired and/or wireless connectivity with the network 102 and the other components of the system 100, for example the store 182, or the user device 184, etc. For instance, the communication unit 202 may include, but is not limited to, CAT-type interfaces; wireless transceivers for sending and receiving signals using Wi-Fi™; Bluetooth®, cellular communications, etc.; USB interfaces; various combinations thereof; etc. The communication unit 202 may be coupled to the other components of the enterprise system 110 via the bus 212a or 212b. The communication unit 202 may be coupled to the network 102 as illustrated by the signal line 206 or directly to any other component of the system 100 by the signal line 206. In some implementations, the communication unit 202 can link the processor(s) 204 to the network 102, which may in turn be coupled to other processing systems. The communication unit 202 can provide other connections to the network 102 and to other entities of the system 100 using various standard communication protocols, including, for example, those discussed elsewhere herein.

As depicted in FIG. 2A, the aggregator engine 150 may include an intelligence builder 252, a key attribute identifier 254, and an attribute augmenter module 256. These components 252, 254, and 256 may be communicatively coupled by the bus 212a and/or the processor(s) 204 to one another and/or the other components 120, 125, 130, 132, 134a . . . 134n, 180, 182, and 184 of the enterprise system 110. In some implementations, one or more of the components 252, 254, and 256 are sets of instructions executable by the processor(s) 204 to provide their functionality. In other implementations, one or more of the components 252, 254, and 256 are stored in the memory(ies) 222 of the enterprise system 110 and are accessible and executable by the processor(s) 204 to provide their functionality. In any of the foregoing implementations, these components 252, 254, and 256 may be adapted for cooperation and communication with the processor(s) 204 and other components of the enterprise system 110.

The intelligence builder 252 includes software, logic, and/or routines for receiving first-party data from the enterprise data store 132 and using the first-party data to build one or more enhanced customer profiles 230.

In some implementations the intelligence builder 252 may retrieve the first-party data 232 from the various components of the system 100 associated with the enterprise system 110, such as the store 182, the call center 180, the business engine 170, the ecommerce engine 145, etc., and stores the aggregated data in the enterprise data store 132. In some implementations the intelligence builder 252 may aggregate the third-party data from the third-party data stores 134a . . . 134n and store it in the enterprise data store 132 for quick access by other engines and modules.

An enhanced customer profile 230 is a set of data that describes the probable attributes of a customer. In some implementations, an enhanced customer profile 230 includes a plurality of attributes segmented from the first-party data and enhanced using the third-party data.

In some implementations, the intelligence builder 252 may generate an enhanced customer profile 230 by combining aspects of the third-party data 234 with the first-party data 232. For instance, the intelligence builder 252 may combine matching aspects of the first-party data 232 pertaining to a customer and the third-party data 234 pertaining to a customer and generate the enhanced customer profile 230 based thereon. In some implementations, the intelligence builder 252 may define a set of foundational attributes types for a given user, segment the first-party data 232 for values matching the attributes, and then use the attributes as a framework around which to organize the third-party data 234. In some implementations the intelligence builder 252 may score the attributes based on the trustworthiness/reliability of the source data from which the values for the attributes were segmented, the number of sources containing the same values, the sources themselves, etc.

The intelligence builder 252 may store, update, and or delete the enhanced customer profiles 230 in the profile data store 130. The intelligence builder 252 may interact with the key attribute identifier 254 to determine attributes for the enhanced customer profile 230. The intelligence builder 252 may be coupled to the key attribute identifier 254 and/or a data store to receive attribute-related data generated by the key attribute identifier 254.

The key attribute identifier 254 includes software, logic, and/or routines for identifying attributes using first-party data. Attributes may be single attributes or combinations of attributes. Attributes may include, but are not limited to gender, location, job title, company name, company type, company size, income, spending potential, and any other relevant attribute. In some implementations the key attribute identifier 254 may set and segment the first-party data (e.g., first-party data, third-party data) to identify the attributes. The key attribute identifier 254 may use the trustworthiness of the various sources, data types, and attributes to score the attributes. In some implementations the key attribute identifier 254 may apply machine learning techniques to determine the values for various attributes, such as product association, company type, various attributes that can be used in sales production and ecommerce activities, etc.

The attribute augmenter module 256 includes software, logic, and/or routines for strengthening the depth of understanding in the enhanced customer profile 230. In some implementations, the attribute augmenter module 256 may combine individual pieces of data from the third-party data 234 with individual pieces of data in the first-party data 232 (e.g., the attributes identified by the key attribute identifier 254) to create a deeper understanding of the key attributes and/or the enhanced attributes. For instance, the attribute augmenter module 256 may augment the attributes identified by the key attribute identifier 254 to create enhanced attributes. An enhanced attribute may be an initial attribute that has been augmented (e.g., confirmed, supplemented, revised, etc.) using third-party data to better ensure the accuracy of the attribute. In some implementations, the attribute augmenter module 256 may be configured to extrapolate further details and/or attributes in the enhanced customer profile 230 based at least partially on data within the enhanced customer profile 230.

In some implementations, the attribute augmenter module 256 may augment scores of the attributes and in some cases assign scores where scores may have not yet been defined (e.g., in the case where there is insufficient supporting data from the first-party data), as discussed further elsewhere herein.

In some implementations, the attribute augmenter module 256 may rank the data sources from which the third-party data was aggregated and use the rankings when augmenting the scores of the attributes in the customer profile, as discussed in further detail elsewhere herein.

The attribute augmenter module 256 may be coupled to the intelligence builder 252, the key attribute identifier 254, the profile data store 130, and/or the enterprise data store 132 to send and receive data. In some implementations the attribute augmenter module 256 may be coupled more directly to third-party data stores 134a . . . 134n to retrieve third-party data to use to enhance the customer attributes.

The probability analysis module 262 includes software, logic, and/or routines for determining a probable user action for a user by analyzing the first-party data 232, third-party data 234, user attributes (types, values, and scores), product information, data source information, trustworthiness information, etc. The probable user action may be included by the probability analysis module 262 in the enhanced customer profile as an attribute. In some implementations, the probability analysis module 262 may rank and rate the actions based on effectiveness for completing a transaction or other ecommerce result. The effectiveness may be based on brand recognition, customer testing, incentives, past behavior of the customer, and any other relevant data.

The probability analysis module 262 may be coupled directly to the modules 252, 254, and/or 256, the profile data store 130, and/or the enterprise data store 132.

The rules engine 160 may be communicatively coupled by the bus 212a and/or the processor(s) 204 to one another and/or the other components 120, 125, 130, 132, 134a . . . 134n, 180, 182, and 184 of the enterprise system 110. In some implementations, the rules engine 160 includes sets of instructions executable by the processor(s) 204 to provide their functionality. In some implementations, the rules engine 160 may be stored in the memory(ies) 222 of the enterprise system 110 and are accessible and executable by the processor(s) 204 to provide its functionality. In any of the foregoing implementations, the rules engine 160 may be adapted for cooperation and communication with the processor(s) 204 and other components of the enterprise system 110.

The rules engine 160 includes software, logic, and/or routines for creating rules. The rules engine 160 may process a set of rules designed to influence one or more of the customers of a merchant based on the attributes included in the corresponding enhanced customer profiles. Rules may be defined on a per user basis, may be defined globally for all users, or maybe to find for a group of users who share similar attributes.

In some implementations, base rules may be manually defined (e.g., input) by a developer or administrator and the rules engine 160 may use machine learning to further enhance and/or develop the rules. In some implementations, the rules engine 160 analyzes the customer profiles, first and third-party data, business data, etc., and automatically creates the rules based thereon. Other variations are also possible and contemplated.

In some implementations, the rules engine 160 consider the attribute scores when selecting predictions to provide to the ecommerce engine 145 or business engine 170 for various customers. For instance, predictions generated based on attributes have less certain scores (e.g., less than 50%) may be discarded in favor of predictions generated based on attributes having more certain scores (e.g., scores greater than 50%). In some implementations, the rules engine 160 may be configured to determine the disposition (e.g., intent) of the customer when generating a prediction using the real-time intelligence data in association with that customer enhanced customer profile, as discussed elsewhere herein.

Real-time intelligence includes any data acquired in real-time or near real-time associated with the current or recent actions of a customer/user 190 and/or any products and/or incentives currently or recently associated with the customer. In some implementations, the real-time intelligence data may reflect the user's identity and/or current on-site or in-app behavior (e.g., referrer, selections, items in cart, path, etc.). Real-time intelligence data may be received from various information sources, including the ecommerce engine 145, the business engine 170, the store 182, the user device 184, the call center 180, third-party information sources, etc.

In some implementations, the rules engine 160 may monitor the result of a prediction generated based on a given based on the actions of the customer. For instance, the rules engine 160 may analyze first-party data and/or real-time intelligence data for evidence that the user acted upon the prediction (e.g., purchased a product predicted for the customer). Based on the monitoring, the rules engine 160 may update the corresponding rule(s) and/or the customer's enhanced customer profile.

In some implementations, the ecommerce engine 145 and/or business engine 170 may be configured to personalize the shopping experience of the customer by enhancing the content provided to a customer for display. For instance, the ecommerce engine 145 and/or business engine 170 may change the price, the products, the arrangement of the products, etc., in the content (e.g., shopping webpage, marketing email, etc.) being provided to the customer to influence the customer to purchase one or more of the products.

In some implementations, the rules engine 160 may be coupled to the profile data store 130, the aggregator engine 150, the ecommerce engine 145, or components thereof, other components of the system 100, etc., to send and receive data.

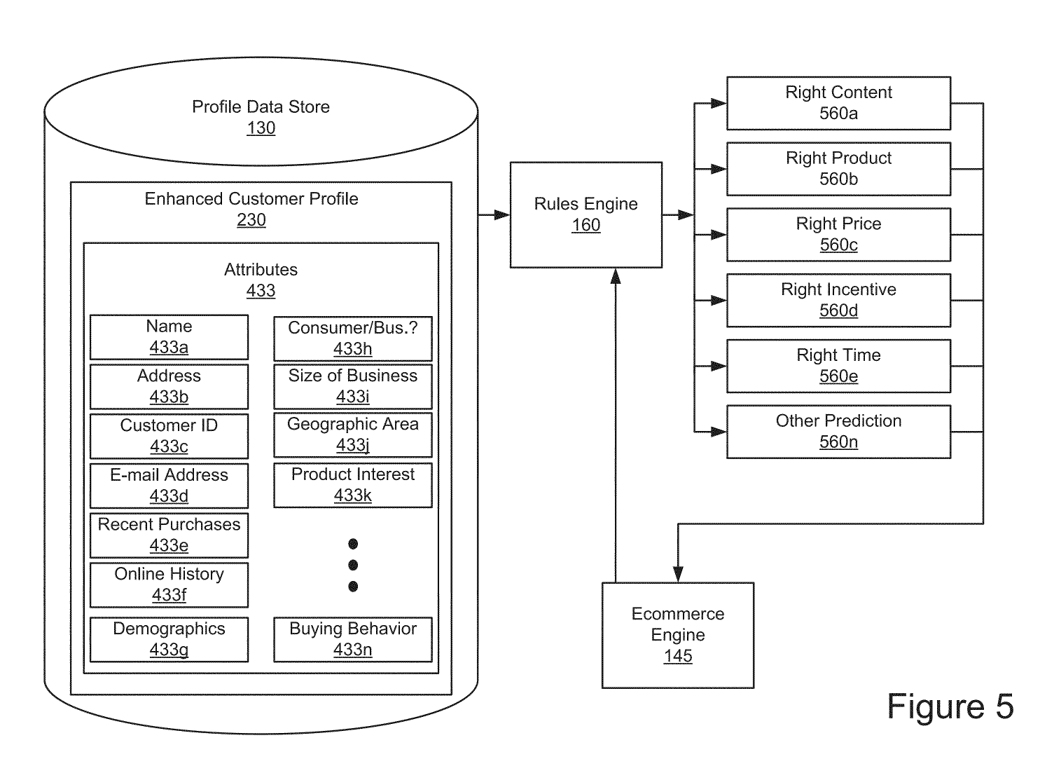

FIG. 4 is a block diagram illustrating example data flows associated with an example aggregator engine 150. In this figure, the aggregator engine 150 receives first-party data and third-party data from various information sources. For example, the aggregator engine 150 receives household data 134a, network ecosystem data 134b, online history data 134c, mobile intelligence data 134d, site journey data 134e, competitive intelligence data 134f, retail/online transactions 332a, ecommerce analytics 332b, mobile app Intel 332c, call center analytics 332d, and customer loyalty data 332e, although other types of information are also contemplated and encompassed by the scope of the disclosure.

The aggregator engine 150 processes the first-party and third-party data to generate enhanced customer profile for a given customer. The enhanced customer profile may include a plurality of attributes 433, such as a name 433a, an address 433b, a customer ID 433c, an email address 433d, recent purchases 433e, online history 433f, demographics 433g, business 433h, size of business 433i, geographic area 433j, product interest 433k, . . . buying behavior 433n. The aggregator engine 150 may store the enhanced customer profile 230 in the profile data store 130, which includes a plurality of attributes 433, as discussed elsewhere herein.

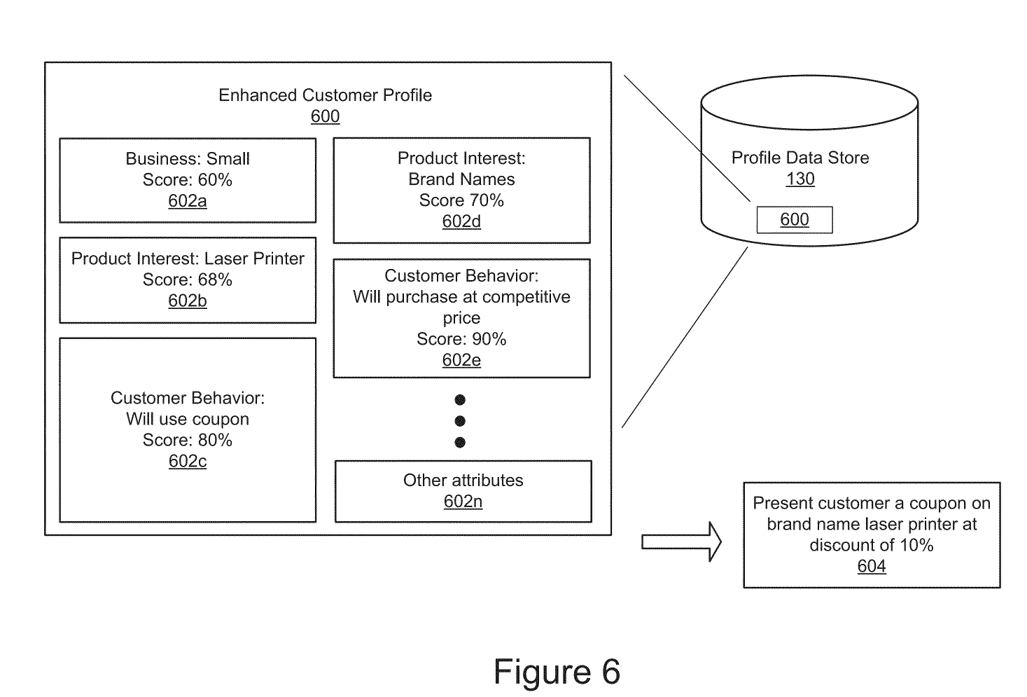

FIG. 5 is a block diagram illustrating example data flows associated with a rules engine 160. As depicted, the rules engine 160 may query the profile data store 130 for an enhance customer profile 230 of a given customer, which may include a plurality of attributes as discussed above with reference to FIG. 4. Using a plurality of rules, the rules engine 160 may predict the customer's current dispositions. As input for the rules, the rules engine 160 may receive real-time intelligence data from other components of the system 100, such as the ecommerce server 125. In further implementations, the rules engine 160 may receive real-time intelligence data from other sources such as the business engine 170, third-parties, etc.

The predictions of a given customer's disposition may include predictions of the right content 560a, the right product 560b, the right price 560c, the right incentive 560d, the right time 560e, and/or other predictions 560n. Disposition predictions may be used singularly or cumulatively by the ecommerce engine 145, the business engine 170, or another component of the system 100, to motivate customers to purchase products in the most effective way possible by personalizing the content provided to them based on the predictions. For example, the ecommerce engine 145 may adapt webpages or other information provided to customers to what is perceived as that customer's current disposition, whether it be explicit or implicit.

In some implementations, several predictions for a customer may be processed at the same time by the rules engine 160 and used in combination to serve up content to the customer that is most likely to convert sales of products to that customer. In some implementations, a given prediction, such as the right price 560c, may use another prediction as an input, such as the right product 560b. This is advantageous because not only will the rules engine 160 predict what the right price for a given product is for a given customer, but also may predict the right product as well.

In some implementations, a rule may include the logic for predicting more than one aspect, such as the right product, the right price, and/or at the right time. For instance, based on the attributes in the customer's profile (e.g., product interest 433k, buying behavior 433n, online history 433f, demographics, etc.), the rules engine 160 may be able to determine with reasonable certainty that a given customer would purchase personalized photographs (e.g., Christmas photos) at a certain price point, but may suppress that prediction until the right time (e.g., the weeks preceding the Christmas holiday) before marketing the product at that price point to the customer.

While the disposition predictions are referred to in this figure in the singular, it should be understood that more than one item may be predicted by a rule. For example, a prediction may include a plurality of products that a customer might currently be disposed to purchasing, given the right timing, placement within the webpage, pricing, etc. The products may embody a package of products are products that are interrelated are connected somehow, such as a printer, printer paper, replacement cartridges for the printer, etc. In this example, the right price 560c disposition prediction may reflect a discounted price for the entire package of products and/or tiered discounted prices the products of the package. The right content 560a prediction may suggest displaying the package or products prominently or subtlety to the user via the interface, depending on what has worked most effectively for that customer in the past. The right content 560a prediction might also suggest certain imagery and/or language be used to tailor the advertisement of the package of products to the user. It should be understood that the foregoing is just one example of many variations that can be provided by the rules engine 160.

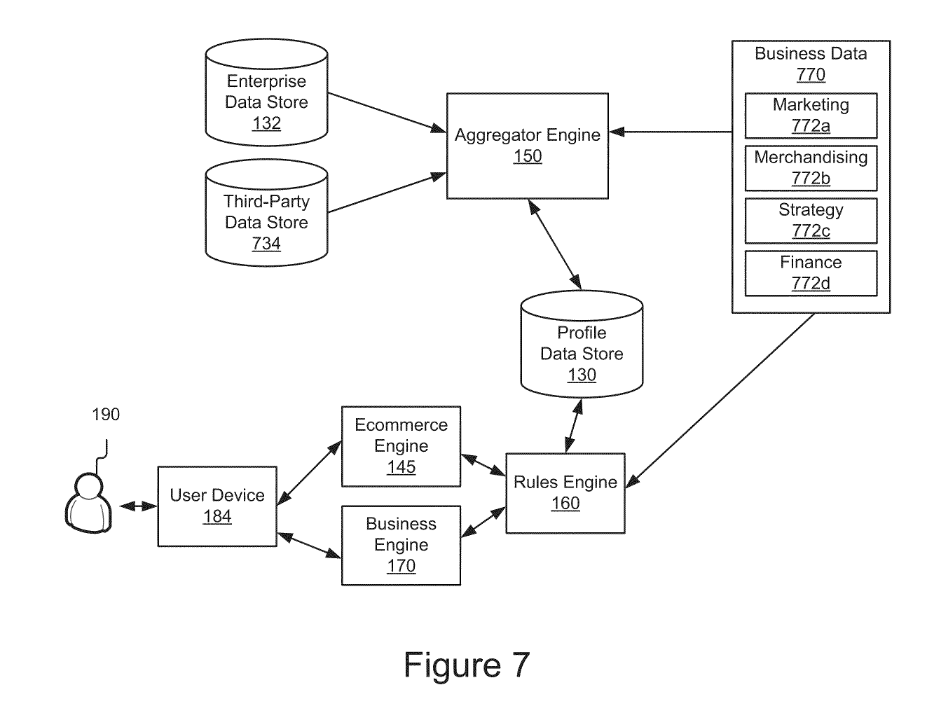

FIG. 6 is an example of an enhanced customer profile 600 for a particular example customer. The enhanced customer profile 600 includes various attributes that were determined based on the user's past behavior with the merchant or other merchants as reflected by the first-party data or the third-party data, respectively. For example, attribute 602a reflects that the customer is associated with the small business. In some implementations, the value and score for this attribute may be determined from information provided by the customer when registering with the merchant (e.g., information submitted in a customer loyalty (e.g., rewards) form, information submitted when registering an account with the ecommerce service, etc.), providing billing information for prior purchases, the user's professional profile on a social media services (e.g., LinkedIn™), other data sources, a combination of the foregoing. The more data sources that reflect the user being associated with the small business, the more confidence the rules engine 160 can have in that attribute, which is reflected by a stronger (e.g., higher) score value. The confidence in each of these data sources and/or the confidence in particular types of data may also affect the score value.

Similarly, the other attributes 602b, 602c, 602d, 602e, and 602n reflect the customers product preferences and behavior when shopping. The product preferences may be segmented from the first-party data and/or the third-party data and, as with the attribute 602a, the scores for these attributes may be determined and strengthened and/or weakened over time depending on how the first-party data and the third-party data change over time. It should be understood that in some implementations the first-party data and the third-party data are aggregated at various intervals over time so the customer profiles can be continually enhanced. This provides the advantage of ensuring the predictions computed by the rules engine 160 are as accurate as possible to maximize conversion rate. In this example the score values in the edge views range from 0 to 100%, however any arbitrary scale may be used for scoring the attributes.

Since the attributes 602b . . . 602e respectively reflect with reasonable probability (e.g., greater than 50%) that the customer would purchase a laser printer discounted to competitive prices using a coupon, upon a visit from that customer as reflected by the real-time intelligence data, the rules engine 160 would predict this disposition using the corresponding rule and provide the prediction to the ecommerce engine 145 for use thereby to customize information being presented to the customer, such as an on-screen coupon reflecting a 10% discount on a laser printer as shown in block 604, which the user can redeem upon virtual checkout.

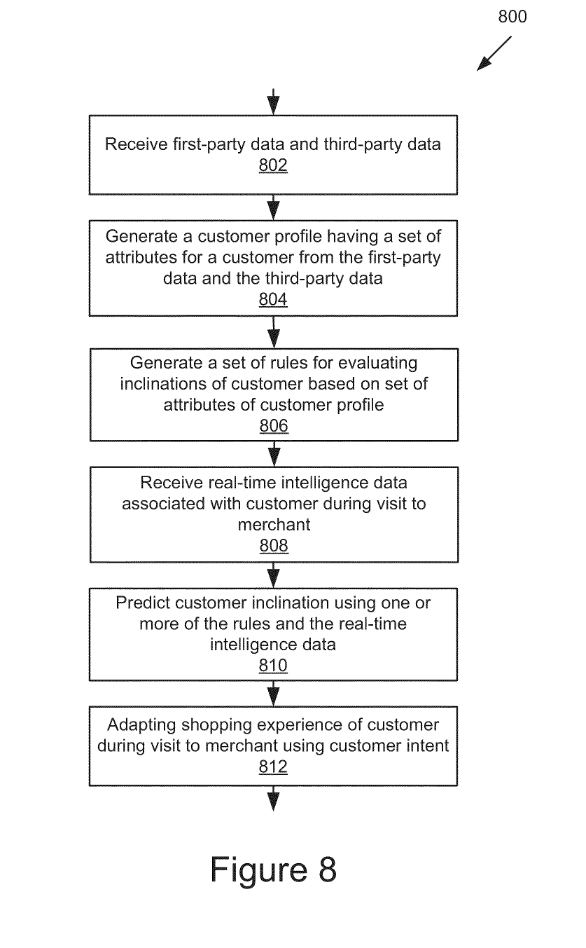

FIG. 7 is a data flow diagram illustrating an example data flow for the system 100. The aggregator engine 150 is configured to receive first-party data and a third-party data from the enterprise data store 132 and/or configured to receive third-party data from a third-party data store 734. The aggregator engine 150 is further configured to receive business data. In some implementations, the aggregator engine 150 may aggregate this data from remote or local data stores, such as the enterprise data store 132.

Business data 770 may include marketing data 772a, merchandising data 772b, strategy data 772c, and finance data 772d, etc. Marketing data 772a may describe promotional content of the merchant, such as e-mail, text message, and social media messages, display advertising, mobile advertising, digital in-store advertisements, etc. Merchandising data 772b may describe in-store product locations, shelving locations, point-of-sale displays, product design and packaging, display strategies, availability of certain products, pricing, etc. Strategy data 772c describes the overall business strategy, product release strategy, etc. Finance data 772d describes the financials of the merchant including product trends, which products are selling ahead of expectations, which products are meeting sales expectations, and which products are below sales expectations, financial benchmarks and goals, overall financial health, etc.

The aggregator engine 150 may be coupled to the profile data store 130 to access, store, update, and or delete data in the profile data store 130, such as the customer profiles, attributes, etc. The rules engine 160 may be coupled to receive the customer profiles from the profile data store 130, business data 770 from a remote or local data store, and real-time intelligence data from the ecommerce engine 145 and/or the business engine 170 (or another information sources (e.g., a third-party data store) and use this data to process one or more rules to generate predictions for provision to the ecommerce engine 145 and/or the business engine 170. The ecommerce engine 145 and/or the business engine 170 may be coupled to the rules engine 160 to receive the disposition predictions and use the predictions on the content provided by them to the user device 184. The user device 184 may be coupled to the ecommerce engine 145 and/or the business engine 170, depending on the embodiment, to receive content personalized to the customer's disposition. The content is personalized in a way to meet the intent, desires, wants, etc., of the customer, and thus increase the probability that the user will purchase products associated with the content, as discussed elsewhere herein.

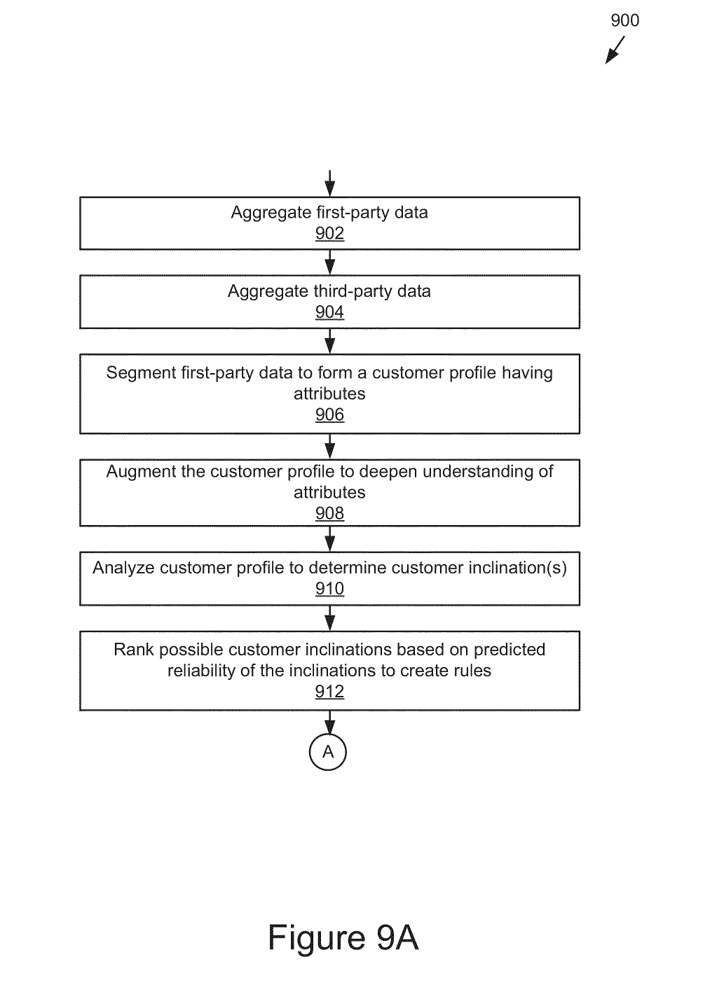

FIG. 8 is a flowchart illustrating an example method 800 for personalizing and optimizing on-site content. In block 802, the method 800 receives first-party data and third-party data. In some implementations, the intelligence builder 252 may aggregate the third-party data from various third-party information sources, such as those discussed elsewhere herein, and store the data in the enterprise data store 132 as third-party data 234. In block 804, the method 800 may generate a customer profile having a set of attributes for customer of a merchant. The method 800 may generate 804 the customer profile based on the first-party data and the third-party data.

In block 806, the method 800 may generate a set of rules for evaluating the dispositions of the customer based on the set of attributes of the customer profile. In some implementations, the rules may reflect methods that may be used to predict different outcomes in conjunction with real-time intelligence data that is gathered when the customer interacts with an ecommerce service and/or marketing materials. For example, a rule may be configured to evaluate the products that the customer is looking for based on the navigation and menu options that the user selecting in the interface of the client application (e.g., a webpage, a shopping mobile application, etc.). In another example, a rule may be configured to evaluate what types of promotions included in marketing e-mails sent to a customer are effective for that customer based on which promotions and/or interface selection options the user interacts with, if any. Numerous other rule variations are also possible, as discussed elsewhere herein.

In block 808, the method 800 receives real-time intelligence data associated with the customer during a visit to the merchant or an interaction with marketing content of the merchant. In some implementations, the visit to the merchant may be a visit to an ecommerce website associated with the merchant and the real-time intelligence data may reflect the behavior of the customer on the ecommerce website, such as on-site paths, product and/or product categories of interest, search keywords, referrer, etc., product pricing, market conditions, etc., as discussed elsewhere herein.

In some implementations, the real-time intelligence data may be collected server side, client side, a combination of the foregoing, etc. In an example, client-side software code associated with the merchant's ecommerce website or various third-party analytics services, may track the customer's activities across various web domains using cookies, web trackers, etc., and provide that data to the probability analysis module 262.

In some implementations, the visit to the merchant may be a visit to a brick and mortar store of the merchant and the real-time intelligence data may reflect products selected by the customer and placed in his or her shopping cart, products browse by the customer on the shelves of the store, etc. The products selected and or browsed by the customer may be tracked in some examples using near field radiofrequency technology, such as RFID tags. The location of the customer may be tracked using location data associated with the customer's client device, location data associated with the products placed in the customers shopping cart and/or interacted with by the customer. While not depicted, the system 100 may include in-store position tracking systems, such as systems that are computed to track the locations of wireless computing devices using radio frequencies emitted by those devices (e.g., Wi-Fi™ and Bluetooth®). In some cases these systems use identifying information associated with the wireless frequencies emitted by those devices, such as media access control (MAC) addresses, to track the location of those devices within the store 182. These in-store position tracking systems may be coupled to and/or incorporated with point-of-sale systems of the store 182 the location data collected by these tracking systems may be provided to the rules engine 160 in real-time and or near real-time.

In block 810, the method 800 predicts customer disposition using one or more of the rules and the real-time intelligence data and in block 812 adapts the shopping experience of the customer during the visit to the merchant or marketing content of the merchant for the customer using the predicted customer disposition. In some implementations, the rules engine 160 can use the real-time intelligence data to determine the right content, product, price, incentive, time, or other result which may be used to personalize the shopping experience, marketing materials, etc. to the customer. Adapting the shopping experience, the marketing materials, or another aspect of the merchant-customer relationship based on predicted customer dispositions is advantageous as it can yield substantial increases in conversion rates when the customer visits the merchant. In some applications, real-time data reflecting the customer's in-store shopping habits, such as the path the customer takes through the store 182 during his or her visit, can be advantageously used to determine which in-store digital audio and/or visual advertisements would be most effective to present to the customer, can be advantageously combined with other customers' habits to better optimize the placement of products and marketing materials in the store 182, etc.

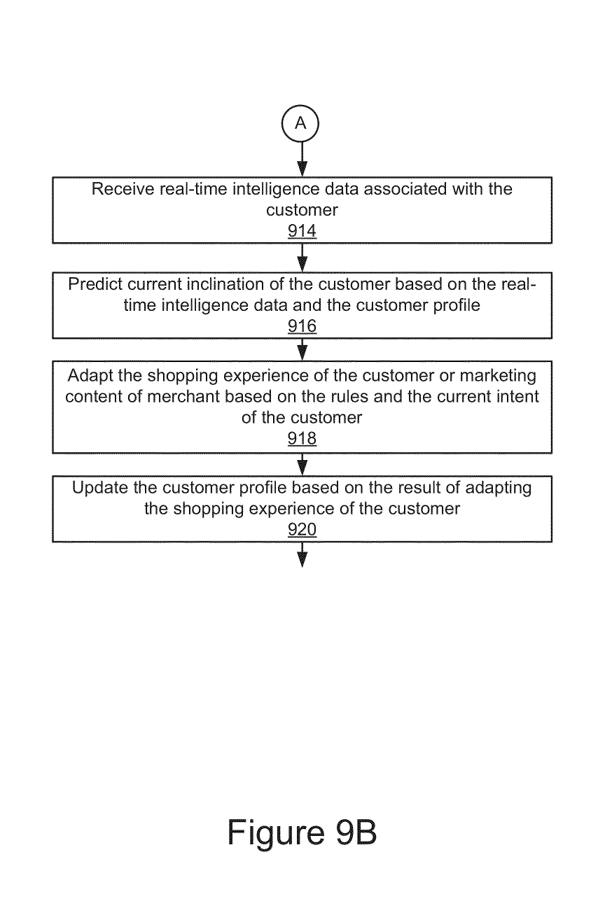

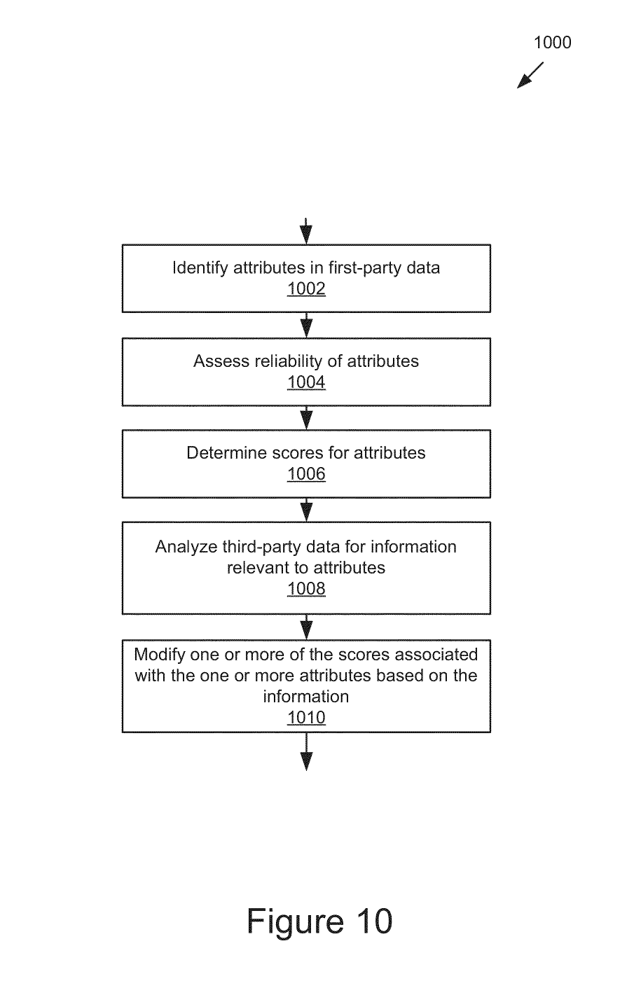

FIGS. 9A and 9B are a flowchart illustrating an example method 900 for personalizing and optimizing on-site content. In block 902, the method 900 aggregates first-party data (e.g., data associated with the enterprise system 110) and in block 904, the method 900 aggregates third-party data. Next, the method 900 segments 906 the first-party data to form a customer profile having attributes and augmenting 908 the customer profile to deepen understanding of attributes. An example method 1000 associated with block 906 is depicted in FIG. 10. In block 1002, the method 1000 segments the first-party data to identify the set of attributes associated with the customer profile. In some implementations, the key attribute identifier 254 uses a predetermined set of attribute types and segments the first-party data to identify attribute values for the different types, such as values for the customer's name, address, gender, age, location, job title, company, company type, etc.

In block 1004, the method 1000 assesses reliabilities of the attributes of the initial set. The reliability of a particular attribute may be determined based on the type and amount of information the first-party data included about that attribute. In some cases, relatively little or no information may be available about a particular attribute, in which case the attribute may be assessed as unreliable by the key attribute identifier 254. In other cases, conclusive information may be available about a particular attribute, such as vendor-validated customer data, such billing information provided by a credit card company for a credit card associated with a customer, is which case the attribute may be assessed as reliable by the key attribute identifier 254. In further cases, unverified attributes about a customer may be assessed as ranging from unreliable to reliable depending on the amount of information available, the number of different data sources indicating the same or conflicting information for the attributes, the integrity of the data sources, etc.

In block 1006, the method 1000 determines scores for the attributes based on the reliabilities. The scores for the attributes may be assessed using any arbitrary scale or scoring system. In some implementations, for each attribute, a type, value, and a score is included in the customer profile. In block 1008, the method 1000 analyzes the third-party data for information relevant to one or more of the attributes and modifies, in block 1010, one or more of the scores associated with the one or more of the attributes based on the information relevant to the one or more of the attributes. In some implementations, the attribute augmenter module 256 performs these operations to strengthen the depth of the content included in the customer profile of the customers, as discussed in further detail elsewhere herein. As the first-party data can in some cases be a complete or include information that is unreliable, enhancing the customer profile using the third-party data allows the attributes of the customer profile to be further verified, thereby producing more reliable predictions of customer dispositions.

Returning to FIG. 9A, in block 910, the method 900 continues by analyzing the customer profile to determine one or more dispositions of the customer and ranks, in block 912, the customer dispositions based on the reliability of the attributes associated with dispositions to create rules. In some implementations, the rules engine 160 analyzes the attributes of a given customer profile to determine and rank the customer dispositions, as discussed elsewhere herein. In some implementations, base rules are input by a developer or administrator and the rules engine 160 uses machine learning to further enhance and/or develop the rules. Other variations are also possible and contemplated, such as those where rules are automatically generated by the rules engine 160.

In block 914, the method 900 receives real-time intelligence data associated with the customer, predicts the current disposition of the customer based on the real-time intelligence data and the customer profile in block 916, and adapts the shopping experience of the customer during a visit to the merchant or marketing content of the merchant for the customer using the predicted disposition in block 918.

In block 920, the method 900 updates the customer profile based on the result of adapting the shopping experience of the customer. In some implementations, in block 920, the probability analysis module 262 determines effectiveness of predicting the customer disposition based on whether the customer purchased an associated product, updates the customer profile of the customer to reflect the effectiveness of predicting the customer disposition, and uses the effectiveness of predicting the customer disposition to more accurately predict subsequent customer disposition during a subsequent visit to the merchant or for future marketing content.

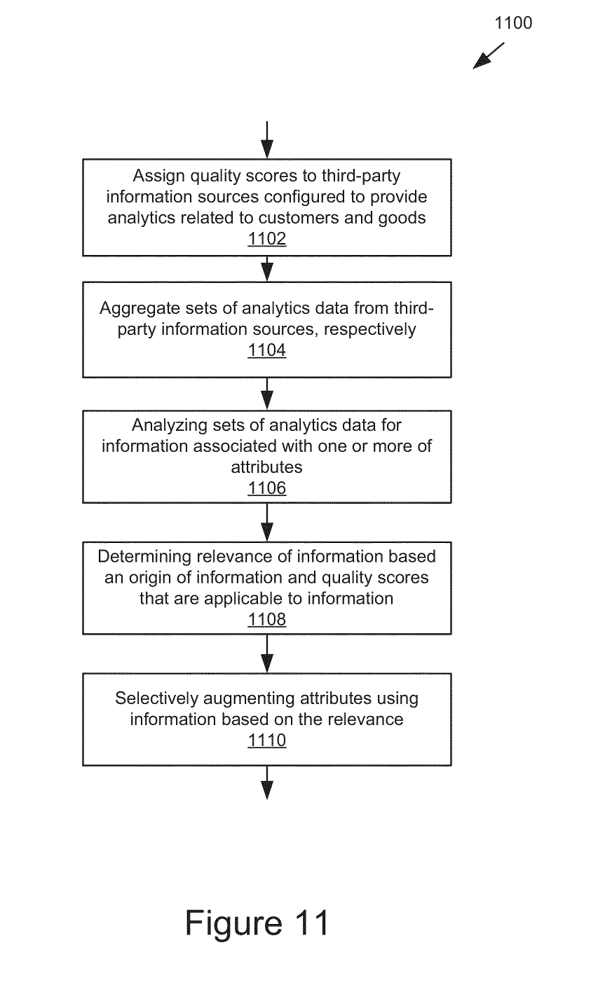

FIG. 11 is a flowchart illustrating an example method 1100 for determining the current intent of the customer based on real-time intelligence data and a customer profile.

In block 1102, the method of 1100 assigns quality scores to third-party information sources that are configured to provide analytics related to customers and/or goods. In some implementations, the varying third-party information sources may not provide equally reliable data in all cases. By ranking the third-party information sources using the quality scores, more weight to be given to the information received from third-party information sources that have been deemed to provide consistently high quality and reliable information where less weight is given to the information received from third party information sources that have been unreliable in the past or may have incomplete data sets about the customer. It should be understood that the quality scores of the third-party information sources may be dynamic and change over time as the information provided by those data sources improves or degrades. In some implementations, the quality scores are manually assigned by an administrator using an associated graphical user-interface (e.g., an admin webpage or application). The quality scores/rankings of the third-party information sources may be stored in a data store, such as the enterprise data store 132 and retrieved by the attribute augmenter module 256 or another component of the system 100, such as the aggregator engine 150, when evaluating the third-party data.

In block 1104, the method 1100 aggregates sets of analytics data from the third-party information sources, respectively. In some implementations, the intelligence builder 252 and/or the attribute augmenter module 256 baby couple to receive the sets of analytics data from the third-party information sources. Non-limiting examples of third-party information sources are depicted in FIG. 1 as 134a . . . 134n.

In block 1106, the method 1100 analyzes the sets of analytics data for information associated with one or more of the attributes, as discussed elsewhere herein, and in block 1108, the method 1100 determines the relevance of the information based on an origin of the information and quality scores that are applicable to the information. This is advantageous because information that any confirmed by multiple of the third-party data sources is likely to be more reliable, particularly if the quality scores of the information sources reflect that the data provided by those information sources is also considered reliable. In block 1110, the method 1100 selectively augments the attributes using the information based on the relevance. This augmentation of the attributes beneficial because it enables predictions of customer dispositions to be more accurate. This in turn yields higher conversion rates when those customers visit the merchant because of the personalized experience provided those customers.

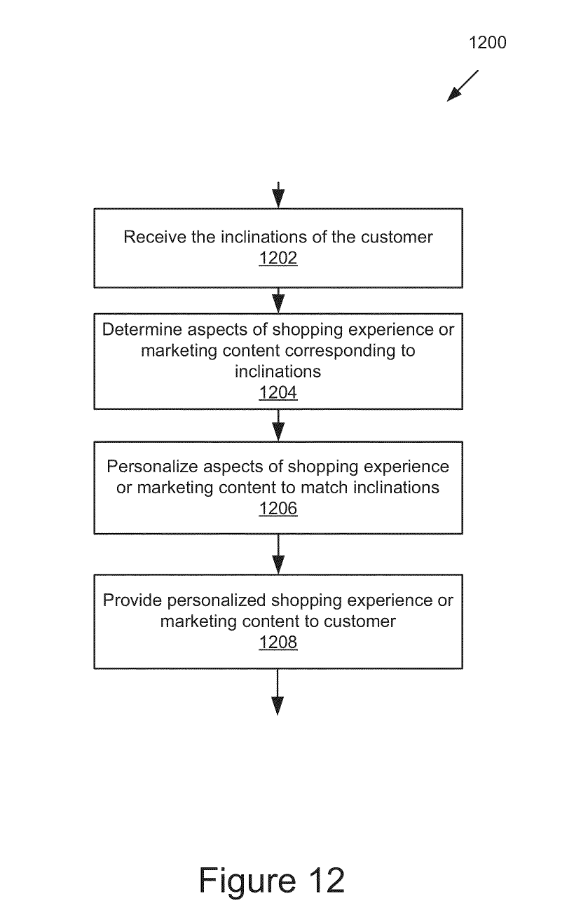

FIG. 12 is a flowchart illustrating an example method 1200 for adapting the shopping experience or marketing materials associated with the customer based on the rules and the disposition(s) of the customer. In block 1202, the method 1200 receives the disposition(s) of the customer and determines one or more aspects of the shopping experience or marketing materials that correspond to the disposition(s) in block 1204. For example, the ecommerce engine 145 may receive the disposition(s) from the probability analysis module 262 and may determine various aspects of the shopping experience that correspond to the dispositions. For example, if disposition is a discount price for a product that the customer would find attractive, that ecommerce engine 145 would identify content associated with the price for the product and adapt that content to reflect the discount price (e.g., on sale for $19.99, a 20% savings). In block 1208, the personalized shopping experience or marketing content is provided to the customer.

In some implementations relating to the provision of marketing materials to a customer, the business engine 170 may adapt the content of the marketing material, such as a promotional e-mail sent to the customer based on the customer's own personal dispositions. For example, a particular customer may routinely call the call center 180 of the merchant and a particular type of advertisement is included in an e-mail message or text message sent to that customer. Now assume the next generation of the message is updated with the new format and sent to the customer on the customer does not call in, which would be reflected in the call-center analytics of the first-party data. Because a conversion rate worsened, the intelligence builder 252, or another component of the aggregator engine 150, would update the customer's profile to reflect that that particular form of advertising was not effective for the customer should not be used. In a further example, assume a particular customer routinely visited various other websites to purchase certain types of electronics, as reflected in the third-party data. Using this data, the customer's profile could be updated to augment a product attribute to reflect the user frequently purchases these types of electronics and marketing e-mail may be sent to the user which is personalized with a discount for these types of electronics. It should be understood that numerous other examples are possible and contemplated.

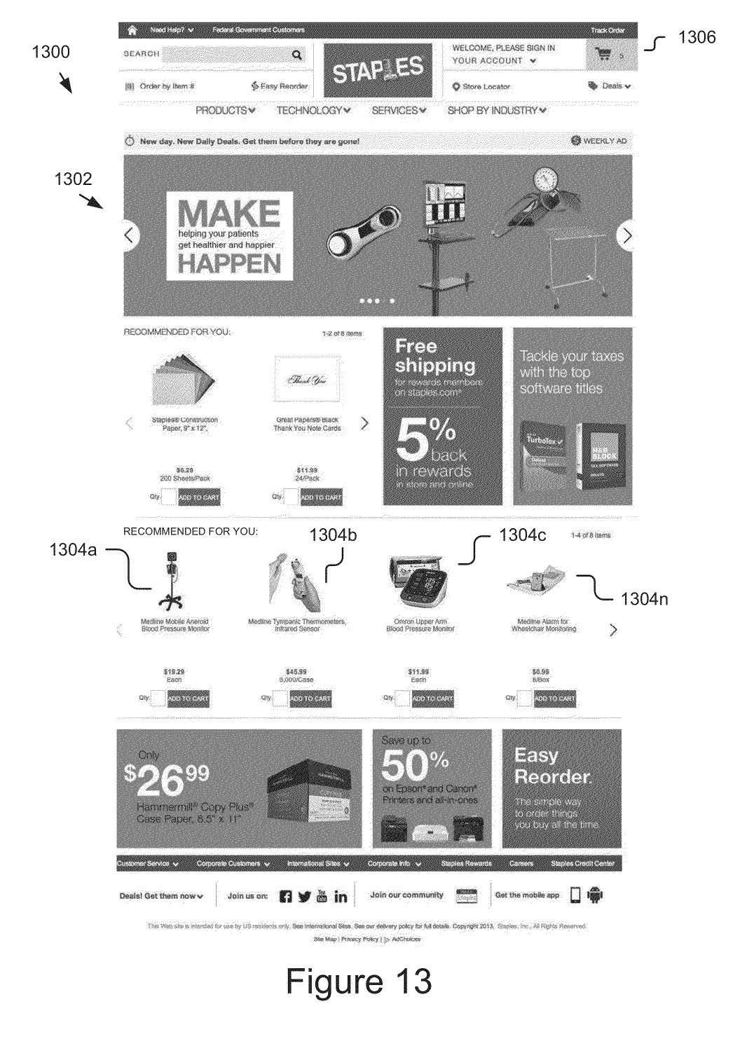

FIG. 13 is a graphic representation of an example personalized interface 1300 provided by the system. The interface 1300 includes various elements for selecting products, navigating different product categories, logging in to a customer account and accessing account options, adding items to a cart for virtual checkout, etc. In this example, the interface 1300 may be loaded when a customer visits a website or opens a mobile application of a merchant, although other variations are possible and contemplated. When the user interface 1300 is loaded, the ecommerce engine 145, client code associated with the ecommerce engine 145 operable by the customer's user device 184, etc., may send real-time intelligence about the customer to the rules engine 160, and the rules engine 160 may identify products that the customer would be dispositioned to purchasing based on the real-time intelligence data and/or the attributes from the enhanced customer profile associated with the customer.

For instance, the enhanced customer profile may include an attribute derived from the third-party data such as the prior history, IP intelligence, industry data, etc., that identifies the customer as a healthcare professional with 90% certainty. Based on this attribute, a corresponding rule processed by the rules engine may suggest particular healthcare-related promotional content be displayed to the customer, such as the advertisement 1302 and the products 1304a . . . n. In some embodiments, the system 1300 is capable of identifying the customer with high probability even if the customer is not logged in as shown by 1306.

Other non-limiting examples of rules may include:
Using a user type (business versus consumer) attribute (a value for which may be segmented from e.g., the customer's prior history or household date included in the third-party data), rule(s) processed by the rules engine 160 can suggest professional grade furniture in the assortment for a long day's work;
Using a recently reactivated customer attribute (a value for which may be segmented from first-party data indicating e.g., user activity or account status), rule(s) processed by the rules engine 160 can suggest welcoming customer back with prominent display of unique offer (e.g., 20% off next purchase);
Using an return attribute (a value for which may be segmented from navigation path data and purchase history data indicating the customer is returning a product online which was bought from the store), rule(s) processed by the rules engine 160 can suggest personalizing return center experience to recognize the customer and offer relevant recommendations for a replacement;
Using a call-center initiated reactivation attribute (a value for which may be segmented from first-party data including call center data), when customer visits a page associated with the ecommerce service after the call center interaction (as indicated by the real-time intelligence data) for some purpose (e.g., read reviews of the product), rule(s) processed by the rules engine 160 can suggest honoring the offer made by call center representative; and
Using a business type attribute (e.g., “accounting firm” segmented industry data included in third-party data) and a real-time click stream data pattern, rule(s) processed by the rules engine 160 can suggest prominently displaying specific highly-relevant products, such as “columnar pads”, within a large assortment of paper product choices.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of an entirely hardware implementation, an entirely software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and Modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, AMQP, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A computer-implemented method comprising:
receiving, using one or more computing devices, first-party data and third-party data;
generating, using the one or more computing devices, a customer profile for the customer of a merchant based on the first-party data and the third-party data, the customer profile having a set of attributes;
generating, using the one or more computing devices, a set of rules for evaluating a disposition of the customer based on the set of attributes of the customer profile;
receiving, using the one or more computing devices, real-time intelligence data associated with the customer during a visit to the merchant or an interaction with marketing content of the merchant; and
predicting, using the one or more computing devices, a disposition of the customer using the real-time intelligence data and one or more of the rules; and
adapting, using the one or more computing devices, a shopping experience of the customer during the visit to the merchant or a marketing content of the merchant for the customer using the predicted disposition.

2. The computer-implemented method of claim 1, wherein
predicting the disposition of the customer includes analyzing the real-time intelligence data using the one or more of the rules to determine one or more updates to the shopping experience or the marketing content, and
adapting the shopping experience of the customer or the marketing content includes personalizing the shopping experience or the marketing content using the one or more updates to improve a customer conversion rate associated with the customer during the visit or a future visit to the merchant.

3. The computer implemented method of claim 1, further comprising:
determining an effectiveness of predicting the disposition of the customer based on whether the customer purchased an associated product;
updating the customer profile to reflect the effectiveness of predicting the disposition of the customer; and
using the effectiveness of predicting the disposition of the customer to more accurately predict a subsequent disposition of the customer during a subsequent visit to the merchant or for future marketing content.

4. The computer-implemented method of claim 1, wherein generating the customer profile for the customer of the merchant based on the first-party data and the third-party data includes
segmenting the first-party data to identify the set of attributes associated with the customer profile,
assessing reliabilities of the attributes of the initial set, and
determining scores for the attributes based on the reliabilities of the attributes.

5. The computer-implemented method of claim 4, wherein generating the customer profile for the customer of the merchant based on the first-party data and the third-party data includes
analyzing the third-party data for information relevant to one or more of the attributes, and
modifying one or more of the scores associated with the one or more of the attributes based on the information relevant to the one or more of the attributes.

6. The computer implemented method of claim 1, further comprising:
assigning quality scores to third-party information sources configured to provide analytics related to customers and goods; and
aggregating sets of analytics data from the third-party information sources, respectively, the sets of analytics data comprising the third-party data, wherein generating the customer profile for the customer of the merchant based on the first-party data and the third-party data includes analyzing the sets of analytics data for information associated with one or more of the attributes,
determining the relevance of the information based on an origin of the information and the quality scores that are applicable to the information, and
selectively augmenting the attributes using the information based on the relevance.

7. The computer implemented method of claim 1, wherein the real-time intelligence data includes one or more of a current behavior of the customer, a current market condition, and a product price.

8. The computer implemented method of claim 1, wherein the first-party data further includes one or more of cross-channel transaction data, ecommerce analytics data, location analytics data, and call center analytics data and the third-party data includes one or more of network ecosystem data, online history data, household data, mobile intelligence data, site journey data, and competitive intelligence data.

9. A computer program product comprising a non-transitory computer-usable medium including instructions which, when executed by a computer, cause the computer to:
receive first-party data and third-party data;
generate a customer profile for the customer of a merchant based on the first-party data and the third-party data, the customer profile having a set of attributes;
generate a set of rules for evaluating a disposition of the customer based on the set of attributes of the customer profile;
receive real-time intelligence data associated with the customer during a visit to the merchant or an interaction with marketing content of the merchant; and
predict a disposition of the customer using the real-time intelligence data and one or more of the rules; and
adapt a shopping experience of the customer during the visit to the merchant or a marketing content of the merchant for the customer using the predicted disposition.

10. The computer program product of claim 9, wherein the instructions further cause the computer to:
predict the disposition of the customer includes analyzing the real-time intelligence data using the one or more of the rules to determine one or more updates to the shopping experience or the marketing content, and
adapt the shopping experience of the customer or the marketing content includes personalizing the shopping experience or the marketing content using the one or more updates to improve a customer conversion rate associated with the customer during the visit or a future visit to the merchant.

11. The computer program product of claim 9, wherein the instructions further cause the computer to:
determine an effectiveness of predicting the disposition of the customer based on whether the customer purchased an associated product;
update the customer profile to reflect the effectiveness of predicting the disposition of the customer; and
use the effectiveness of predicting the disposition of the customer to more accurately predict a subsequent disposition of the customer during a subsequent visit to the merchant or for future marketing content.

12. The computer program product of claim 9, wherein to generate the customer profile for the customer of the merchant based on the first-party data and the third-party data includes
segmenting the first-party data to identify the set of attributes associated with the customer profile,
assessing reliabilities of the attributes of the initial set, and
determining scores for the attributes based on the reliabilities of the attributes.

13. The computer program product of claim 12, wherein to generate the customer profile for the customer of the merchant based on the first-party data and the third-party data includes
analyzing the third-party data for information relevant to one or more of the attributes, and
modifying one or more of the scores associated with the one or more of the attributes based on the information relevant to the one or more of the attributes.

14. The computer program product of claim 9, wherein the instructions further cause the computer to:
assign quality scores to third-party information sources configured to provide analytics related to customers and goods; and
aggregate sets of analytics data from the third-party information sources, respectively, the sets of analytics data comprising the third-party data, wherein to generate the customer profile for the customer of the merchant based on the first-party data and the third-party data includes
analyzing the sets of analytics data for information associated with one or more of the attributes,
determining the relevance of the information based on an origin of the information and the quality scores that are applicable to the information, and
selectively augmenting the attributes using the information based on the relevance.

15. The computer program product of claim 9, wherein the real-time intelligence data includes one or more of a current behavior of the customer, a current market condition, and a product price.

16. The computer program product of claim 9, wherein the first-party data further includes one or more of cross-channel transaction data, ecommerce analytics data, location analytics data, and call center analytics data and the third-party data includes one or more of network ecosystem data, online history data, household data, mobile intelligence data, site journey data, and competitive intelligence data.

17. A system comprising:
one or more processors, the processors being configured to:
receive first-party data and third-party data;
generate a customer profile for the customer of a merchant based on the first-party data and the third-party data, the customer profile having a set of attributes;
generate a set of rules for evaluating a disposition of the customer based on the set of attributes of the customer profile;
receive real-time intelligence data associated with the customer during a visit to the merchant or an interaction with marketing content of the merchant; and
predict a disposition of the customer using the real-time intelligence data and one or more of the rules; and
adapt a shopping experience of the customer during the visit to the merchant or a marketing content of the merchant for the customer using the predicted disposition.

18. The system of claim 17, wherein the one or more processors are further configured to:
predict the disposition of the customer includes analyzing the real-time intelligence data using the one or more of the rules to determine one or more updates to the shopping experience or the marketing content, and
adapt the shopping experience of the customer or the marketing content includes personalizing the shopping experience or the marketing content using the one or more updates to improve a customer conversion rate associated with the customer during the visit or a future visit to the merchant.

19. The system of claim 17, wherein the one or more processors are further configured to:
determine an effectiveness of predicting the disposition of the customer based on whether the customer purchased an associated product;
update the customer profile to reflect the effectiveness of predicting the disposition of the customer; and
use the effectiveness of predicting the disposition of the customer to more accurately predict a subsequent disposition of the customer during a subsequent visit to the merchant or for future marketing content.

20. The system of claim 17, wherein to generate the customer profile for the customer of the merchant based on the first-party data and the third-party data includes
segmenting the first-party data to identify the set of attributes associated with the customer profile,
assessing reliabilities of the attributes of the initial set, and
determining scores for the attributes based on the reliabilities of the attributes.

21. The system of claim 19, wherein to generate the customer profile for the customer of the merchant based on the first-party data and the third-party data includes
analyzing the third-party data for information relevant to one or more of the attributes, and
modifying one or more of the scores associated with the one or more of the attributes based on the information relevant to the one or more of the attributes.

22. The system of claim 17, wherein the instructions further cause the computer to:
assign quality scores to third-party information sources configured to provide analytics related to customers and goods; and
aggregate sets of analytics data from the third-party information sources, respectively, the sets of analytics data comprising the third-party data, wherein to generate the customer profile for the customer of the merchant based on the first-party data and the third-party data includes
analyzing the sets of analytics data for information associated with one or more of the attributes,
determining the relevance of the information based on an origin of the information and the quality scores that are applicable to the information, and
selectively augmenting the attributes using the information based on the relevance.

23. The system of claim 17, wherein the real-time intelligence data includes one or more of a current behavior of the customer, a current market condition, and a product price.

24. The system of claim 17, wherein the first-party data further includes one or more of cross-channel transaction data, ecommerce analytics data, location analytics data, and call center analytics data and the third-party data includes one or more of network ecosystem data, online history data, household data, mobile intelligence data, site journey data, and competitive intelligence data.
